(19) United States
(12) Patent Application Publication
(10) Pub. No.: US 2006/0134980 A1
(43) Pub. Date: Jun. 22, 2006

(54) Engine mounting insulator

(76) Inventor: He-Up Park, Hwaseong-si (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/302,078

(22) Filed: Dec. 12, 2005

(30) Foreign Application Priority Data
Dec. 17, 2004 (KR) 10-2004-0107907

(51) Int. Cl. H01R 9/05

(52) U.S. Cl. 439/585

(57) ABSTRACT

The inner periphery of the main rubber of an engine mounting insulator has a smaller diameter portion along the anteroposterior axis and a larger diameter portion along the lateral axis, thus supporting longitudinal and lateral loads individually.

### CROSS-REFERENCE TO RELATED APPLICATIONS

The present application is based on, and claims priority from, Korean Applicaiton Serial Number 10-2004-0107907, filed on Dec. 17, 2004, the disclosure of which is hereby incorporated by reference herein in its entirety.

### FIELD OF THE INVENTION

The present invention relates to an engine mounting insulator that supports the load of the vehicle and attenuates vibration thereof in the longitudinal and lateral directions of the vehicle, individually.

### BACKGROUND OF THE INVENTION

Generally, an engine mounting insulator is installed between the lower portion of the engine (or the assembly of the engine and transmission) and a vehicle body for supporting the load applied in the vertical direction of the vehicle and attenuating the vibration therebetween.

It is advantageous for the engine mounting insulator to receive the load in the lateral direction during vehicle rolling and in the longitudinal direction during sudden starts and stops of the vehicle.

The longitudinally applied load during a sudden start or stop of the vehicle is greatly larger than the load laterally applied during the vehicle rolling. Therefore, the engine mounting insulator should preferably support the laterally applied load and dampen the vibration thereof and, simultaneously, support the load applied in the anteroposterior direction of the vehicle and dampen the vibration thereof, separately.

### SUMMARY OF THE INVENTION

Embodiments of the present invention provide an engine mounting insulator that is installed between the lower portion of the engine (or the assembly of the engine and transmission) and the vehicle body for supporting the laterally applied load of the vehicle and attenuating vibration thereof and for supporting the longitudinally applied load of the vehicle and attenuating the vibration.

An engine mounting insulator includes a center boss enclosing a lower portion of a center bolt coupled to a weight. A main rubber has an inner portion surrounding an outer portion of the center boss. The outer portion of the center boss is coupled in a housing, and the inner periphery of the main rubber is formed with a smaller diameter portion and larger diameter portion according to the anteroposterior and lateral direction of the vehicle.

### BRIEF DESCRIPTION OF THE DRAWINGS

For a better understanding of the nature and objects of the present invention, reference should be made to the following detailed description with the accompanying drawings, in which:

FIG. 1 is a longitudinal sectional view of an engine mounting insulator according to an embodiment of the present invention; and

FIG. 2 is a cross-sectional view taken along line II-II of FIG. 1, illustrating the inner configuration of a main rubber.

### DETAILED DESCRIPTION OF THE PREFERRED EMBODIMENTS

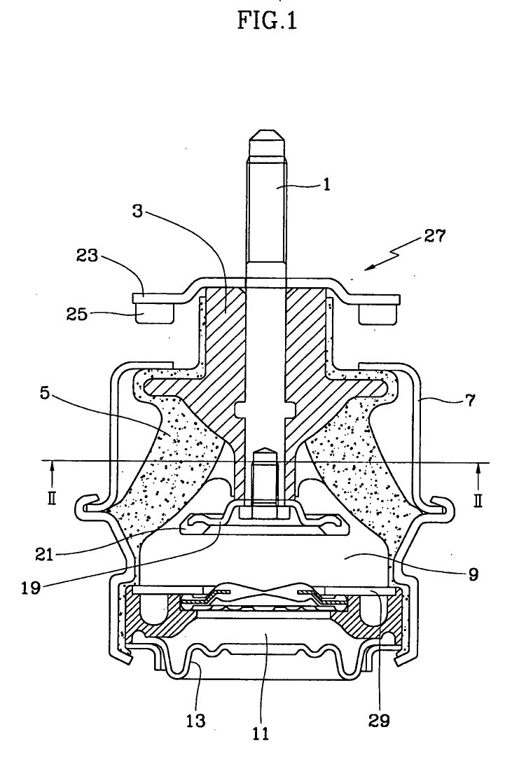

With reference to FIG. 1, a center bolt I is coupled to an upper center portion of a weight (not shown). The weight can be either an engine or an assembly of the engine and transmission.

The lower portion of center bolt I is enclosed by a center boss 3 for receiving the load transmitted from center bolt 1.

A main rubber 5 is mounted at the outer lower portion of center boss 3. The inner portion of main rubber 5 surrounds the periphery of center boss 3, while the outer portion of the main rubber 5 is coupled in a housing 7 via vulcanization.

The lower portion of main rubber 5 is formed with a first liquid storage 9 and second liquid storage 11. A nozzle unit (with an orifice), membrane, and the like are equipped between first liquid storage 9 and second liquid storage 11, and second liquid storage 11 is formed with a diaphragm 13 at the bottom thereof.

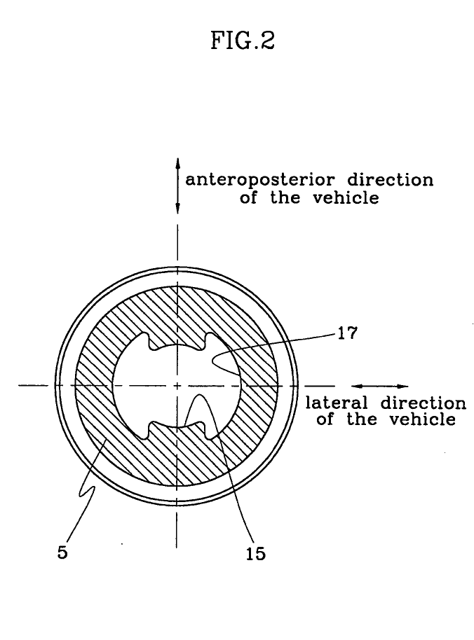

Referring to FIG. 2, the inner periphery of main rubber 5 is formed with a smaller diameter portion 15 and larger diameter portion 17 according to the anteroposterior and lateral directions of the vehicle, respectively. Center boss 3 and center bolt 1 mounted in main rubber 5 are not shown in FIG. 2. The inner periphery of smaller diameter portion 15 is roundly formed to correspond and contact the outer periphery of center boss 3.

In another embodiment, the inner periphery of smaller diameter portion 15 is distanced from the outer periphery of center boss 3. In this case, the distance from the outer periphery of center boss 3 to the inner periphery of larger diameter portion 17 is greater than the distance from the outer periphery of center boss 3 to the inner periphery of smaller diameter portion 15. The different properties according to the directions of the load applied to the engine mounting insulator are based on the different distances described above.

Smaller diameter portion 15, larger diameter portion 17, and center bolt I are concentric.

The smaller diameter portion 15 of main rubber 5 is aligned along the anteroposterior direction of the vehicle, and larger diameter portion 17 is aligned along the lateral direction of the vehicle.

In first liquid storage 9 formed underneath main rubber 5, a plunger plate 19 is coupled at the bottom of center bolt 1. A damping rubber 21 is further mounted around the frame of plunger plate 19.

The upper surface of center boss 3 is coupled with a stopper plate 23 having stopper rubbers 25 thereunder.

A separate bracket is equipped at the outer lower portion of housing 7 and is supported by the vehicle body.

In the case of a vertically applied load, the load is supported and vibration is attenuated by the elastic deformation of main rubber 5 and the shift of fluid between first and second liquid storages 9 and II. If a large amount of load is applied in the vertical direction, stopper rubber 25 contacts the upper surface of housing 7 to function as a secondary damping operation. The impact remaining after the secondary damping is reduced still further when damping rubber 21 coupled with plunger plate 19 contacts a nozzle cover 29.

For loads due to vehicle rolling, sudden start or stop, the different properties against the load applied in different directions accomplished by means of main rubber 5 serve to properly support the load according to each situation and attenuate the vibration thereof.

A small load is applied to engine mounting insulator 27 during vehicle rolling compared to sudden start or stop of the vehicle by deforming the portion where larger diameter portion 17 of main rubber 5 is formed. Accordingly, the engine mounting insulator provides a relatively small spring rigidity by larger diameter portion 17.

When the vehicle suddenly starts or stops, a relatively large load is transmitted to engine mounting insulator 27 by deforming the portion where smaller diameter portion 15 of main rubber 5 is formed. Engine mounting insulator 27 thus provides a relatively high spring rigidity by using smaller diameter portion 15.

As apparent from the foregoing, there is an advantage in that the inner configuration of the main rubber of the engine mounting insulator is adapted to have directionality, thereby separately implementing support of laterally applied loads and attenuating vibration thereof as well as support of longitudinally applied loads and attenuating the vibration thereof.

What is claimed is:

1. An engine mounting insulator, comprising:
a center boss enclosing a lower portion of a center bolt that is coupled to a weight; and
a main rubber having an inner periphery that surrounds said center boss, and an outer portion that is coupled to a housing, wherein the inner periphery of said main rubber has a smaller diameter portion and a larger diameter portion.

2. The insulator as defined in claim 1, wherein said smaller diameter portion of the inner periphery is configured and dimensioned to contact an outer periphery of said center boss.

3. The insulator as defined in claim 1, wherein said smaller diameter portion and said larger diameter portion are concentric.

4. The insulator as defined in claim 1, wherein said smaller diameter portion of said main rubber is aligned along the anteroposterior direction of the vehicle, and said larger diameter portion is aligned along the lateral direction of the vehicle.

5. The insulator as defined in claim 1, further comprising:
a first liquid storage underneath the main rubber.

6. The insulator as defined in claim 5, further comprising:
a second liquid storage underneath the first liquid storage, wherein said first and second liquid storages are connected with a nozzle and a membrane.

7. The insulator as defined in claim 6, wherein said second liquid storage is formed with a diaphragm at a bottom thereof.

8. The insulator as defined in claim 1, further comprising:
a plunger plate coupled at a lower end of said center bolt; and
a damping rubber mounted around a frame of said plunger plate.

9. The insulator as defined in claim 8, further comprising:
a first liquid storage underneath the main rubber,
wherein said plunger plate is disposed in said first liquid storage.

10. The insulator as defined in claim 1, further comprising:
a stopper plate coupled to an upper surface of said center boss and having at least one stopper rubber at a bottom surface thereof.
